(19) United States
(12) Patent Application Publication
(10) Pub. No.: US 2009/0326191 A1
(43) Pub. Date: Dec. 31, 2009

(54) WATER REPELLENT POWDER DRYING METHOD, PRODUCING METHOD, AND PRODUCING APPARATUS

(76) Inventors: Shinichirou Kobayashi, Osaka (JP); Teruo Kido, Osaka (JP); Tomonori Kikuno, Osaka (JP); Yasuhiro Utsumi, Osaka (JP); Takayuki Tanaka, Osaka (JP); Satoshi Tokuno, Osaka (JP)

Correspondence Address: BIRCH STEWART KOLASCH & BIRCH, PO BOX 747, FALLS CHURCH, VA, 22040-0747, US

(21) Appl. No.: 12/375,866

(22) PCT Filed: Jul. 18, 2007
(86) PCT No.: PCT/JP2007/064157

§ 371 Date: Jan. 30, 2009

(30) Foreign Application Priority Data
Jul. 31, 2006 (JP) 2006-209053

(51) Int. Cl. C08F 6/00; F26B 3/34

(52) U.S. Cl. 528/503; 34/265

(57) ABSTRACT

A semi-finished product obtained as a mixture of PTFE powder and water is put on conveyance trays (70) and is then input to a producing apparatus (10). In the producing apparatus (10), the conveyance trays (70) arranged vertically pass through a first drying zone (41), a second drying zone (42), and a heat treatment zone (43) in this order. In the first drying zone (41), the water contained in the semi-finished product is heated by a microwave to be evaporated. In the second drying zone (42), residual water in the semi-finished product is heated by hot wind to be evaporated. In the heat treatment zone (43), the temperature of dried PTFE powder is kept at approximately 160° C. The semi-finished product on each conveyance tray (70) passes through the three zones to be PTFE powder as a finished product.

### TECHNICAL FIELD

As water repellent powder, powder made of fluorine containing resin, such as polytetrafluoroethylene (hereinafter referred to as “PTFE”) and the like has been known. The powder made of such a kind of fluorine containing resin may be utilized as a material for, for example, coverings of wires, and various kinds of molded products. In order to produce a molded product using water repellent powder as a material, the water repellent powder may be extrusion molded at high temperature. In such a case, if moisture remains in the material, i.e., the water repellent powder, the moisture may abruptly evaporate in molding to cause formation of a hole or crack in the molded product. In view of this, the water repellent powder used as a material for molded products must have an extremely low water content.

In the process of, for example, producing the water repellent powder, polymerization or the like may be caused in water. In such a case, the water repellent powder can be obtained as a semi-finished product in a slurry state containing a large amount of water. For this reason, the semi-finished product obtained as a mixture of the water repellent powder and water must be dried for obtaining a finished product of the water repellent powder. In this way, the water repellent powder must be dried in relatively many case.

For drying such wet water repellent powder, moisture may be evaporated by blowing high-temperature (about 100 to 200° C.) for example) hot wind to the wet water repellent powder. However, heat conductivities of water repellent powders are not so high in many cases. For this reason, this method requires a extremely long time period for raising the temperature of the wet water repellent powder, with a result that it takes long time for drying the water repellent powder.

It has been proposed to solve this problem, as disclosed in Patent Document 1, by drying a mixture of PTFE powder as one kind of the water repellent powder and water, that is, wet PTFE powder by using a microwave. Since many water repellent powders, such as the PTFE powder and the like hardly absorb the microwave, irradiation of the microwave to the wet water repellent powder can effectively raise only the temperature of the water contained therein. Accordingly, this method reduces the time required for drying the water repellent powder when compared with the case utilizing the hot wind. Patent Document 1: Japanese Unexamined Patent Application Publication 11-235720

### SUMMARY OF THE INVENTION

### Problems that the Invention is to Solve

However, the method in which the microwave is irradiated to the wet water repellent powder encounters difficulty in lowering the amount of residual water therein to a given point or lower. This problem will be described below.

In the process of drying the wet water repellent powder, the interstices among the water repellent particles are filled with water when moisture remains therein to some extent. The condition where the water repellent powder in this state is irradiated with the microwave is the same as the condition where water retained in a vessel or the like is irradiated with the microwave. Almost all part of the irradiated microwave is absorbed in the water remaining with the water repellent powder to evaporate the water increasingly.

In drying a target by utilizing the microwave, it has been known that the ratio of part of the irradiated microwave which is absorbed in water decreases as the ratio of water contained in the target, that is, the water content is lowered. Particularly, water in contact with particles tends to form droplets in a mixture of water repellent powder, such as PTFE powder and water. For this reason, even in the state where the water content is not so low, the water contained in the mixture forms minute droplets to be dispersed in the powder. If the water is dispersed in the powder in forms of droplets having a size fairly smaller than the wavelength of the microwave, the ratio of the microwave absorbed in the water further decreases, and consequently, less or no increase in temperature of the droplets is caused even by further microwave irradiation.

When the content of the residual water in the wet water repellent powder becomes lower than a given value, and the water is dispersed in the form of minute droplets in the water repellent powder, mere microwave irradiation cannot evaporate the water, with a result that that the water content of the water repellent powder may not become lower than the given value.

The present invention has been made in view of the foregoing, and its objective is to lower, in a process of drying wet water repellent powder, the amount of residual water of the water repellent powder to a sufficiently low value within a short period of time.

### Means for Solving the Problems

A first aspect of the present invention is directed to a method for drying water repellent powder. The water repellent powder drying method includes: a first step of evaporating, by irradiating a microwave to wet powder (80) which is a mixture of water repellent powder and water, the water contained in the wet powder (80); and a second step of obtaining dried water repellent powder by heating the wet powder (80) obtained in the first step by hot wind to evaporate residual water in the wet powder (80).

In the first aspect, the first step and the second step are performed in a process until the dried water repellent powder is obtained from the wet powder (80).

Water repellent powders may include resin powder for general purpose use, powder of generally-called engineering plastic, and the like. Specifically, water repellent powders may include powder of any of polyethylene, polyvinyl chloride, polypropylene, polystyrene, polyvinyl acetate, ABS resin (acrylonitrile butadiene styrene resin), AS resin (acrylonitrile-styrene resin), methacrylate resin, polyacetal, polyamide, polyimide, polyamide-imide, polycarbonate, polyphenylene ether, polybutylene terephthalate, polyarylate, polysulfone, polyether sulfone, polyether-imide, polyphenylene sulfide, polyether ether ketone, fluorine containing resin, and the like.

Powders of fluorine containing resin as one kind of the water repellent powder may include powder of any of polytetrafluoroethylene (PTFE), a copolymer of tetrafluoroethylene and hexafluoropropylen (FEP), a copolymer of tetrafluoroethylene and perfluoro-alkyl vinyl ether (PFA), polychlorotrifluoroethylene (PCTFE), polyvinylidene fluoride (PVDF), a copolymer of ethylene and tetrafluoroethylene (ETFE), a copolymer of ethylene and chlorotrifluoroethylene (ECTFE), and the like.

In the first step in the first aspect, the wet powder (80) is irradiated with the microwave. The water contained in the wet powder (80) generates heat by absorbing the microwave to be evaporated. As a result, the amount of the water contained in the wet powder (80) decreases gradually.

In the second step in the first aspect, the hot wind is blown to the wet powder (80) having been subjected to the first step so that the residual water in the wet powder (80) is heated by the hot wind to be evaporated. The wet powder (80) having been subjected to the first step has a water content lowered to some extent, and the residual water is dispersed in forms of minute droplets in some cases. To tackle this problem, the second step evaporates the water by blowing the hot wind rather than microwave irradiation, and therefore, the water in forms of minute droplets is heated to be evaporated.

Referring to a second aspect of the present invention, the first aspect further includes: a third step of keeping the water repellent powder obtained in the second step at a predetermined temperature for a predetermined time period.

In the second aspect, the third step is performed after the first step and the second step. In the third step, the water repellent powder, of which the amount of the residual water has been sufficiently lowered through the first step and the second step and of which the temperature is raised by the hot wind, is kept at the predetermined temperature for the predetermined time period. Referring to, for example, PTFE powder as one kind of the water repellent powder, when it is exposed to given high temperature for a given time period, the pressure (extrusion pressure) necessary for extrusion molding it becomes constant at a given value. The third step is performed for stabilizing the extrusion pressure of the water repellent powder, for example.

Referring to a third aspect of the present invention, in the second aspect, the wet powder (80) is put on a conveyance tray (70), and the conveyance tray (70) carrying the wet powder (80) is moved along a single path to pass through a space (41) for performing the first step, a space (42) for performing the second step, and a space (43) for performing the third step in this order.

In the third aspect, the conveyance tray (70) carrying the wet powder (80) is moved along the single path. In this process, the conveyance tray (70) passes in this order through the space (41) for performing the first step, the space (42) for performing the second step, and the space (43) for performing the third step. During the time when the conveyance tray (70) is moved in the space (41) for performing the first step, the wet powder (80) on the conveyance tray (70) is irradiated with the microwave. During the time when the conveyance tray (70) is moved in the space (42) for performing the second step, the wet powder (80) on the conveyance tray (70) is heated by the hot wind. During the time when the conveyance tray (70) is moved in the space (43) for performing the third step, the water repellent powder on the conveyance tray (70) is kept at the predetermined temperature.

Referring to a fourth aspect of the present invention, in the second or third aspect, in the second step, the wet powder (80) is accommodated in an accommodation space (42) in which ventilation is performed, and the hot wind is allowed to flow in the accommodation space (42), and in the third step, the water repellent powder is accommodated in another accommodation space (43) in which no ventilation is performed, and the air temperature of the other accommodation space (43) is kept at a predetermine value.

In the fourth aspect, the accommodation space (42) is ventilated in the second step. The water evaporated from the wet powder (80) in the second step, that is, vapor is discharged from the accommodation space (42) together with the air in the accommodation space (42). In this aspect, for ventilating the accommodation space (42), all the air flowing out from the accommodation space (42) may be discharged so that the flow rate of the air flowing out from the accommodation space (42) become equal to the flow rate of the outside air supplied to the accommodation space (42). Alternatively, part of the air flowing out from the accommodation space (42) may be discharged so that the other air is mixed with the outside air and is returned to the accommodation space (42).

In the fourth aspect, ventilation of the accommodation space (43) is not performed in the third step for keeping the temperature of the accommodation space (43) at the predetermined value. The third step is performed on the water repellent powder of which the amount of the residual water has been sufficiently lowered through the first step and the second step, and therefore, the water is hardly evaporated from the water repellent powder in the accommodation space (43). In view of this, no ventilation is performed in the accommodation space (43) in this aspect.

Referring to a fifth aspect of the present invention, in the first, second, third, or fourth aspect, in the first step, the wet powder (80) accommodated in an accommodation space (41) is irradiated with the microwave, while the accommodation space (41) is ventilated.

In the fifth aspect, the accommodation space (41) is ventilated in the first step. The water evaporated from the wet powder (80) in the first step, that is, vapor is discharged from the accommodation space (41) together with the air in the accommodation space (41). In this aspect, for ventilating the accommodation space (41), all the air flowing out from the accommodation space (41) may be discharged so that the flow rate of the air flowing out from the accommodation space (41) becomes equal to the flow rate of the outside air supplied to the accommodation space (41). Alternatively, part of the air flowing out from the accommodation space (41) may be discharged so that the other flowing-out air is mixed with the outside air and is returned to the accommodation space (41).

Referring to a sixth aspect of the present invention, in the first, second, third, fourth, or fifth aspect, the method further includes a preheating step of preheating the wet powder (80) immediately before the first step.

In the sixth aspect, the wet powder (80) is heated in the preheating step to raise the temperature of the water contained in the water repellent powder. In the first step, the microwave is irradiated to the wet powder (80) having been preheated in the preheating step.

Referring to a seventh aspect of the present invention, in the first, second, third, fourth, fifth, or sixth aspect, the water repellent powder is powder of polytetrafluoroethylene.

In the seventh aspect, the wet powder (80) as a mixture of the PTFE powder and water is dried to produce dried PTFE powder.

Referring to an eight aspect of the present invention, in the second aspect, in the third step, in order to evaporate an impurity contained in the water repellent powder, the temperature of the water repellent powder is kept higher than the boiling point of the impurity.

In the eighth aspect, the temperature of the water repellent powder having been subjected to the second step is kept higher than the boiling point of the impurity in the water repellent powder for the predetermined time period. In producing water repellent powder, an additive may be added in some cases for the purpose of promoting a reaction for generating particles or the like, for example. In such a case, the additive is liable to remain in the powder as an impurity. To tackle this problem, the water repellent powder is kept at a temperature higher than the billing point of the impurity to evaporate the impurity in the water repellent powder, thereby removing the impurity from the water repellent powder.

A ninth aspect of the present invention is directed to a method for producing water repellent powder as a finished product by performing treatment on a semi-finished product (80) obtained as a mixture of water repellent powder and water in a process of producing the water repellent powder. The method includes: a first step of evaporating the water contained in the semi-finished product (80) by irradiating a microwave to the semi-finished product (80); and a second step of evaporating residual water in the semi-finished product (80) obtained in the first step by heating the semifinished product (80) by hot wind.

In the ninth aspect, the first step and the second step are performed in the process of obtaining the water repellent powder as a finished product from the semi-finished product (80).

In the first step in the ninth aspect, the semi-finished product (80) is irradiated with the microwave. The water contained in the semi-finished product (80) generates beat by absorbing the microwave to be evaporated. As a result, the amount of the water contained in the semi-finished product (20) decreases gradually. In the second step in the ninth aspect, the hot wind is blown to the semi-finished product (80) having been subjected to the first step so that the residual water in the semi-finished product (80) is heated by the hot wind to be evaporated. The semi-finished product (80) having been subjected to the first step has a water content lowered to some extent, and the residual water is dispersed in forms of minute droplets in some cases. To tackle this problem, the second step evaporates the water by the hot wind rather than microwave irradiation, and therefore, the water in form of minute droplets is heated to be evaporated.

Referring to a tenth aspect of the present invention, in the ninth aspect, the method further includes: a third step of obtaining the water repellent powder as the finished product by keeping the semi-finished product (80) obtained in the second step at a predetermined temperature for a predetermined time period.

In the tenth aspect, the third step is performed after the first step and the second step. In the third step, the semi-finished product (80), of which the amount of the residual water has been sufficiently lowered through the first step and the second step and of which the temperature is raised by the hot wind, is kept at the predetermined temperature for the predetermined time period. Referring to, for example, PTFE powder as one kind of the water repellent powder, when it is exposed to given high temperature for a given time period, the pressure (extrusion pressure) necessary for extrusion molding it becomes constant at a given value. The third step is performed for stabilizing the extrusion pressure of the water repellent powder, for example.

Referring to an eleventh aspect of the present invention, in the tenth aspect, the semi-finished product (80) is put on a conveyance tray (70), and the conveyance tray (70) carrying the semi-finished product (80) is moved along a single path to pass through a space (41) for performing the first step, a space (42) for performing the second step, and a space (43) for performing the third step in this order.

In the eleventh aspect, the conveyance tray (70) carrying the semi-finished product (80) is moved along the single path. In this process, the conveyance tray (70) passes in this order through the space (41) for performing the first step, the space (42) for performing the second step, and the space (43) for performing the third step. During the time when the conveyance tray (70) is moved in the space (41) for performing the first step, the semi-finished product (80) on the conveyance tray (70) is irradiated with the microwave. During the time when the conveyance tray (70) is moved in the space (42) for performing the second step, the semi-finished product (80) on the conveyance tray (70) is heated by the hot wind. During the time when the conveyance tray (70) is moved in the space (43) for performing the third step, the semi-finished product (80) on the conveyance tray (70) is kept at the predetermined temperature.

Referring to a twelfth aspect of the present invention, in the tenth or eleventh aspect, in the second step, the semi-finished product (80) is accommodated in an accommodation space (42) in which ventilation is performed, and the hot wind is allowed to flow in the accommodation space (42), and in the third step, the semi-finished product (80) is accommodated in another accommodation space (43) in which no ventilation is performed, and the air temperature of the other accommodation space (43) is kept at a predetermine value.

In the twelfth aspect, the accommodation space (42) is ventilated in the second step. The water evaporated from the semi-finished product (80) in the second step, that is, vapor is discharged from the accommodation space (42) together with the air in the accommodation space (42). In this aspect, for ventilating the accommodation space (42), all the air flowing out from the accommodation space (42) may be discharged so that the flow rate of the air flowing out from the accommodation space (42) become equal to the flow rate of the outside air supplied to the accommodation space (42). Alternatively, part of the air flowing out from the accommodation space (42) may be discharged so that the other air is mixed with the outside air and is returned to the accommodation space (42).

In the twelfth aspect, ventilation of the accommodation space (43) is not performed in the third step for keeping the temperature of the accommodation space (43) at the predetermined value. The third step is performed on the semi-finished product (80) of which the amount of the residual water has been sufficiently lowered through the first step and the second step, and therefore, the water is hardly evaporated from the semi-finished product (80) in the accommodation space (43). In view of this, no ventilation is performed in the accommodation space (43) in this aspect.

Referring to a thirteenth aspect of the present invention, in the ninth, tenth, eleventh, or twelfth aspect, in the first step, the semi-finished product (80) accommodated in an accommodation space (41) is irradiated with the microwave, while the accommodation space (41) is ventilated.

In the thirteenth aspect, the accommodation space (41) is ventilated in the first step. The water evaporated from the semi-finished product (80) in the first step, that is, vapor is discharged from the accommodation space (41) together with the air in the accommodation space (41). In this aspect, for ventilating the accommodation space (41), all the air flowing out from the accommodation space (41) may be discharged so that the flow rate of the air flowing out from the accommodation space (41) becomes equal to the flow rate of the outside air supplied to the accommodation space (41). Alternatively, part of the air flowing out from the accommodation space (41) may be discharged so that the other flowing-out air is mixed with the outside air and is returned to the accommodation space (41).

Referring to a fourteenth aspect of the present invention, in the ninth, tenth, eleventh, twelfth, or thirteenth aspect, the method further includes: a preheating step of preheating the semi-finished product (80) immediately before the first step.

In the fourteenth aspect, the semifinished product (80) is heated in the preheating step to raise the temperature of the water contained therein. In the first step, the microwave is irradiated to the semi-finished product (80) having been preheated in the preheating step.

Referring to a fifteenth aspect of the present invention, in the ninth, tenth, eleventh, twelfth, thirteenth, or fourteenth aspect, the water repellent powder is powder of polytetrafluoroethylene.

In the fifteenth aspect, dried PTFE powder as the finished product is produced from the semi-finished product (80) obtained as a mixture of the PTFE powder and water. Referring to a sixteenth aspect of the present invention) in the tenth aspect, in the third step, in order to evaporate an impurity contained in the semi-finished product (80), the temperature of the semi-finished product (80) is kept higher than the boiling point of the impurity.

In the sixteenth aspect, the temperature of the semi-finished product (80) having been subjected to the second step is kept higher than the boiling point of the impurity in the semi-finished product (80) for the predetermined time period. In producing water repellent powder, an additive may be added in some cases for the purpose of promoting a reaction for generating particles or the like, for example. In such a case, the additive is liable to remain in the powder as an impurity. To tackle this problem, the semi-finished product (80) is kept at a temperature higher than the billing point of the impurity to evaporate the impurity in the semi-finished product (80), thereby removing the impurity from the water repellent powder.

A seventeenth aspect of the present invention is directed to an apparatus for producing water repellent powder as a finished product by performing treatment on a semi-finished product (80) obtained as a mixture of water repellent powder and water in a process of producing the water repellent powder. The apparatus includes: a first treatment section (16) forming a first space (41) for accommodating the semi-finished product (80), and evaporating the water contained in the semi-finished product (80) by irradiating a microwave to the semi-finished product (80) in the first space (41); and a second treatment section (17) forming a second space (42) for accommodating the semi-finished product (80) having passed through the first treatment section (16), and evaporating residual water in the semi-finished product (80) by heating the semi-finished product (80) in the second space (42) by hot wind.

In the seventeenth aspect, the first space (41) and the second space (42) are formed in the first treatment section (16) and the second treatment section (17), respectively.

The first treatment section (16) in the seventeenth aspect irradiates the microwave to the semifinished product (80) accommodated in the first space (41). The water contained in the semifinished product (80) absorbs the microwave to generate heat, thereby being evaporated. As a result, the amount of the water contained in the semi-finished product (80) decreases gradually.

In the second treatment section (17) in the seventeenth aspect, the semi-finished product (80) having passed through the first treatment section (16) is accommodated in second space (42), and the semi-finished product (80) in the second space (42) is heated by the hot wind. The residual water in the semi-finished product (80) heated by the hot wind is evaporated therefrom. The semi-finished product (80) having passed through the first treatment section (16) has a water content lowered to some extent, and therefore, the residual water may be dispersed in forms of minute droplets in some cases. To tackle this problem, the second treatment section (17) evaporates the water by the hot wind rather than microwave irradiation. Hence, the water in forms of the minute droplets is heated to be evaporated.

Referring to an eighteenth aspect of the present invention, in the seventeenth aspect, the apparatus further includes: a third treatment section (18) forming a third space (43) for accommodating the semi-finished product (80) having passed through the second space (17), and obtaining the water repellent powder as the finished product by keeping the semi-finished product (80) in the third space (43) at a predetermined temperature for a predetermined time period.

In the eighteenth aspect, the third space (43) is formed in the third treatment section (18). In the third treatment section (18), the semi-finished product (80) having passed through the second treatment section (17) is accommodated in the third pace (43), and the semi-finished product (80) in the third space (43) is kept at the predetermined temperature for the predetermined time period. In the third treatment section (18), the semi-finished product (80), of which the amount of the residual water is lowered sufficiently and of which the temperature is raised by the hot wind, is kept at the predetermined temperature for the predetermined time period. Referring to, for example, PTFE powder as one kind of the water repellent powder, when it is exposed to given high temperature for a given time period, the pressure (extrusion pressure) necessary for extrusion molding it becomes constant at a given value. The step in the third treatment section (18) is performed for stabilizing the extrusion pressure of the water repellent powder, for example.

Referring to a nineteenth aspect of the present invention, in the eighteenth aspect, the apparatus further includes: a conveyance tray (70) for carrying the semi-finished product (80); and a conveyance mechanism (50) conveying the conveyance tray (70) carrying the semi-finished product (80) along a single path so that the conveyance tray (70) passes through the first treatment section (16), the second treatment section (17), and the third treatment section (18) in this order.

In the nineteenth aspect, the conveyance mechanism (50) moves the conveyance tray (70) carrying the semi-finished product (80) along the single path. In conveyance of the conveyance tray (70) by the conveyance mechanism (50), the conveyance tray (70) passes in this order through first space (41) of the first treatment section (16), the second space (42) of the second treatment section (17), and the third space (43) of the third treatment section (18).

Referring to a twentieth aspect of the present invention, in the eighteenth or nineteenth aspect, the second treatment section (17) allows the hot wind to flow in the second space (42) while performing ventilation of the second space (42), and the third treatment section (18) keeps the air temperature in the third space (43) at a predetermined value while performing no ventilation of the third space (43).

In the twentieth aspect, the second treatment section (17) performs ventilation of the second space (42). The water evaporated from the semi-finished product (80) in the second treatment section (17), that is, vapor is discharged from the second space (42) together with the air in the second space (42). In this aspect, for ventilating the second space (42), all the air flowing out from the second space (42) may be discharged so that the flow rate of the air flowing out from the second space (42) become equal to the flow rate of the outside air supplied to the second space (42). Alternatively, part of the air flowing out from the second space (42) may be discharged so that the other air is mixed with the outside air and is returned to the second space (42).

In the twentieth aspect, ventilation of the third space (43) is not performed in the third treatment section (18) for keeping the temperature of the third space (43) at the predetermined value. The target of the third treatment section (18) is the semi-finished product (80) of which the amount of the residual water has been sufficiently lowered through the first treatment section (16) and the second treatment section (17), and therefore, the water is hardly evaporated from the semi-finished product (80) in the third space (43). In view of this, no ventilation in third space (43) is performed in the third treatment section (18) in this aspect.

Referring to a twenty-first aspect, in the seventeenth, eighteenth, nineteenth, or twentieth aspect, the first treatment section (16) ventilates the first space (41).

In the twenty-first aspect, the first treatment section (16) performs ventilation in the first space (41). The water evaporated from the semi-finished product (80) in the first treatment section (16), that is, vapor is discharged from the first space (41) together with the air in the first space (41). In this aspect, for ventilating the first space (41), all the air flowing out from the first space (41) may be discharged so that the flow rate of the air flowing out from the first space (41) becomes equal to the flow rate of the outside air supplied to the first space (41). Alternatively, part of the air flowing out from the first space (41) may be discharged so that the other flowing-out air is mixed with the outside air and is returned to the first space (41).

Referring to a twenty-second aspect of the present invention, in the seventeenth, eighteenth, nineteenth, twentieth, or twenty-first aspect, the apparatus further includes: a reheating section (19) forming a preheating space (46) for accommodating the semi-finished product (80) immediately before being sent to the first treatment section (16), and heating the semi-finished product (80) in the preheating space (46).

In the twenty-second aspect, the semi-finished product (80) immediately before being sent to the first treatment section (16) is accommodated in the preheating space (46) of the preheating section (19). In the preheating section (19), the semi-finished product (80) accommodated in the preheating space (46) is heated to raise the temperature of the water repellent powder contained in the semi-finished product (80). In the first treatment section (16), the semifinished product (80) preheated in the preheating section (19) is irradiated with the microwave.

Referring to a twenty-third aspect of the present invention, in the seventeenth, eighteenth, nineteenth, twentieth, or twenty-first aspect, the water repellent powder is powder of polytetrafluoroethylene.

In the twenty-third aspect, dried PTFE powder as the finished product is produced from the semi-finished product (80) obtained as a mixture of the PTFE powder and water.

Referring to a twenty-fourth aspect of the present invention, in the eighteenth aspect, the third treatment section (18) keeps, for evaporating an impurity contained in the semi-finished product (80), the temperature of the semi-finished product (80) higher than the boiling point of the impurity.

In the twenty-fourth aspect, the temperature of the semi-finished product (80) having passed through the second treatment section (17) is kept higher than the boiling point of the impurity in the semi-finished product (80) for the predetermined time period in the third treatment section (18). In producing water repellent powder, an additive may be added in some cases for the purpose of promoting a reaction for generating particles or the like, for example. In such a case, the additive is liable to remain in the powder as an impurity. To tackle this problem, the semi-finished product (80) is kept at a temperature higher than the billing point of the impurity to evaporate the impurity in the semi-finished product (80), thereby removing the impurity from the water repellent powder.

### ADVANTAGES OF THE INVENTION

In the present invention, the mixture of the water repellent powder and water, (that is, the wet powder in the first to eighth aspects, and the semi-finished product in the ninth to twenty-fourth aspects) is first irradiated with the microwave to evaporate the water contained in the mixture, and then, the mixture of which the amount of the residual water is lowered to some extent is blown by the hot wind for drying the water repellent powder. In other words, heating by the microwave is performed for quickly evaporating the water when the amount of the residual water of the mixture of the water repellent powder and water is great (namely, when the water is present in a state gathering to some extent in the water repellent powder), while heating by the hot wind is performed for definitely evaporating the water when efficient heating of the water by the microwave cannot be achieved due to a small amount of the residual water of the mixture (namely, when the water in the water repellent powder is dispersed in forms of droplets). Hence, according to the present invention, the amount of the residual water of the water repellent powder as the finished product can be reduced low. Further, according to the present invention, selection of the optimum heating method according to the water content of the mixture of the water repellent powder and water can reduce the time required for drying the mixture of the water repellent powder and water.

In each of the second, tenth, and eighteenth aspects of the present invention, the water repellent powder of which the amount of the residual water has become sufficiently low is kept at the predetermined temperature. Immediately before this step, the mixture of the water repellent powder and water is heated by the hot wind. When the mixture of the water repellent powder and water is heated by the hot wind, not only the temperature of the residual water therein but also that of the water repellent powder increases. In other words, the temperature of the water repellent powder has been raised to some extent at the time point when the step of keeping the water repellent powder at the predetermined temperature starts. Hence, according to these aspects, the time required until the temperature of the water repellent powder reaches a target value in this step can be reduced to reduce the time required for this step.

In each of the third, eleventh, and nineteenth aspects of the present invention, the treatments on the mixture on the conveyance tray (70) are performed sequentially in course of conveying the conveyance tray (70) carrying the mixture of the water repellent powder and water along the single path. In other words, in these aspects, the conveyance tray (70) is moved through the spaces (41, 42, 43) in which the respective treatments are performed. Hence, according to these aspects, even in the case where a plurality of conveyance trays (70) carry the mixture of the water repellent powder and water, the respective treatments can be performed on the mixture on each conveyance tray (70) under the respective same conditions (e.g., the temperature and flow rate of the hot wind, the intensity of the reaching microwave, etc.), with a result that the quality of the finally obtained water repellent powder can be stabilized.

Referring to each of the fourth, twelfth, and twentieth aspects of the present invention, in the step of keeping the water repellent powder having been subjected to drying by the hot wind (that is, the third step in the twelfth aspect, and the step performed in the third treatment section (18) in the twentieth aspect), no ventilation of the space (43) where the water repellent powder is accommodated is performed. Accordingly, in these aspects, the energy required for keeping the air temperature in the space (43) at the predetermined value can be reduced.

In each of the fifth, thirteenth, and twenty-first aspects of the present invention, the space (41) in which the mixture of the water repellent powder and water is accommodated is ventilated, while the mixture in the space (41) is irradiated with the microwave. Accordingly, in these aspects, the water evaporating from the mixture in the space (41), that is, vapor can be discharged quickly outside the space (41) to reduce further the time required for obtaining the water repellent powder in which less or no water remains by drying the mixture.

In each of the sixth, fourteenth, and twenty-second aspects of the present invention, the mixture of the water repellent powder and water is heated to raise the temperature of the water repellent powder to some extent, and is then irradiated with the microwave. This reduces the time required for drying the mixture by microwave irradiation.

This point of view will be described.

Many kinds of water repellent powder absorbs less or no microwave, and therefore, an increase in temperature of the water repellent powder by microwave irradiation is hardly expected. Accordingly, when the microwave is irradiated to the mixture of which the temperature is comparatively low, for example, around 20° C., the temperature of the water in the mixture increases quickly, while the temperature of the water repellent powder in the mixture increases gradually and slowly. In this state, the amount of the residual water of the mixture may lower rather slowly in many cases. The reason thereof might be that almost all water evaporated by heating comes into contact with the low-temperature water repellent powder to be condensed.

In contrast, in each of the sixth, fourteenth, and twenty-second aspects of the present invention, microwave irradiation is performed after the water repellent powder in the mixture is increased in temperature to some extent. Hence, the evaporated water even in contact with the water repellent powder will not be condensed, with a result that the amount of the residual water of the mixture reduces.

Each of the seventh, fifteenth, and twenty-third aspects of the present invention is directed to the PTFE powder as one kind of the water repellent powder. The PTFE has high water repellency, and therefore, water mixed with the PTFE powder is liable to form droplets. Accordingly, in the PTFE powder, it is much difficult to lower the amount of the residual water sufficiently by mere drying by microwave irradiation. In view of this, the mixture of the PTFE powder and water is blown by the hot wind after being subjected to microwave irradiation in these aspects. Hence, according to these aspects, the amount of residual water of the PTFE powder, which has high water repellency, can be reduced definitely.

### BRIEF DESCRIPTION OF THE DRAWINGS

FIG. 1 illustrates schematic views showing an overall construction of a producing apparatus in Embodiment 1, wherein FIG. 1(A) is a plan view of the producing apparatus as viewed from above, and FIG. 1B is a front view thereof as viewed from the front.

FIG. 2 is a front view showing a schematic construction of the producing apparatus in Embodiment 1.

FIG. 3 is a front view showing a schematic construction of a main part of the producing apparatus in Embodiment 1.

FIG. 4 is a sectional view showing a schematic construction of a conveyance tray in Embodiment 1.

FIG. 5 is an enlarged sectional view showing a main part of the conveyance tray in Embodiment 1.

FIG. 6 is a schematic view showing a state variation of a semi-finished product in the producing apparatus.

FIG. 7 is a graph showing a time variation of the state of the semi-finished product in the producing apparatus.

FIG. 8 is a graph showing each relationship between the drying time period and the water content of the semi-finished product in the case where the semi-finished product is heated by microwave and hot wind in combination, in the case where the semi-finished product is heated only by the hot wind, and in the case where the semi-finished product is heated only by the microwave.

FIG. 9 is a front view showing a schematic construction of a producing apparatus in Embodiment 2.

FIG. 10 is a front view showing a main part of a producing apparatus in Modified Example 1 in other embodiments.

FIG. 11 is a front view showing a main part of a producing apparatus in Modified Example 1 in the other embodiments.

FIG. 12 is a front view showing a main part of a producing apparatus in Modified Example 2 in the other embodiments.

FIG. 13 is a front view showing a main part of a producing apparatus in Modified Example 2 in the other embodiments.

FIG. 14 is a front view showing a main part of a producing apparatus in Modified Example 2 in the other embodiments.

FIG. 15 is a graph showing a relationship among the water content of the semi-finished product, the amount of a residual additive, and the drying time period.

### INDEX OF REFERENCE NUMERALS

10 producing apparatus
16 first treatment section
17 second treatment section
18 third treatment section
19 preheating section
41 first drying zone (first space)
42 second drying zone (second space)
43 third drying zone (third space)
46 preheating zone (preheating space)
70 conveyance tray
50 tray driving section (conveyance mechanism)
80 wet powder, semi-finished product

### BEST MODE FOR CARRYING OUT THE INVENTION

Embodiments of the present invention will be described below in detail with reference to the accompanying drawings.

### Embodiment 1 of the Invention

Embodiment 1 of the present invention will now be described.

—Producing Apparatus—

A producing apparatus (10) in the present embodiment is provided for producing dried PTFE powder as a finished product by performing treatments on a semi-finished product (80) obtained as a mixture of PTFE powder and water in a process of producing the PTFE powder. The terms “right,” “left,” “front,” and “back” in the following description mean those as viewed from the front of the producing apparatus (10).

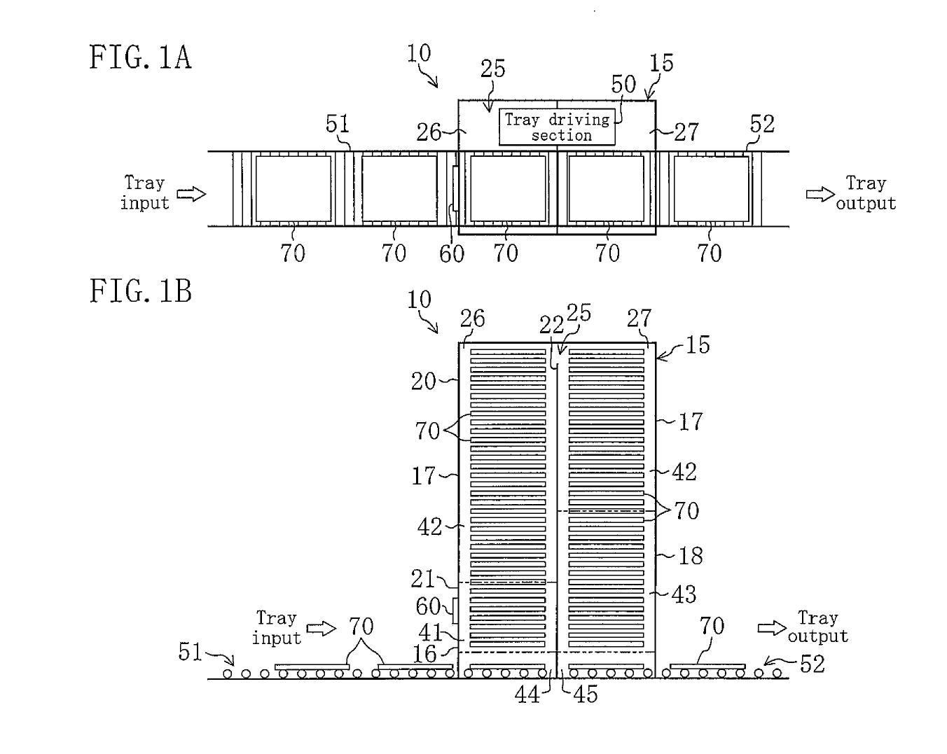

As shown in FIG. 1, a body part (15) of the producing apparatus (10) includes a metal-made body casing (20) formed in a vertically oblong rectangular parallelepiped form. The body casing (20) has a width in the transverse direction longer than the depth thereof. The body casing (20) forms a passage space (25) thereinside. In the passage space (25), a plate-shaped partition wall (22) stands. The passage space (25) is partitioned by the partition wall (22) into a left ascending side space (26) and a right descending side space (27). The height of the partition wall (22) is lower than that of the passage space (25). Accordingly, the upper end part of the ascending side space (26) and the upper end part of the descending side space (27) communicate with each other.

In the lower end part of the body part (15), an input side roller conveyer (51) and an output side roller conveyer (52) are inserted from the left and the right, respectively. The input side roller conveyer (51), of which terminal end is located inside the ascending side space (26), conveys conveyance trays (70) into the ascending side space (26). Each conveyance tray (70) carries the semi-finished product (80). The output side roller conveyer (27), of which start end is located inside the descending side space (27), conveys out the conveyance trays (70) from the descending side space (27). Each conveyance tray (70) carries the PTFE powder as a finished product. The construction of a conveyance tray (70) will be described later.

The body part (15) includes a tray driving section (50) as a conveyance mechanism. Though not shown, the tray driving section (50) includes arm members extending horizontally for receiving the conveyance trays (70). In the tray driving section (50), multiple arm members are arranged at regular intervals. The tray driving section (50) moves each arm member carrying a conveyance tray (70) to convey the conveyance trays (70) in the passage space (25). Specifically, the tray driving section (50) moves the conveyance trays (70) sent into the ascending side space (26) upward, moves the conveyance trays (70) reaching the upper end of the ascending side space (27) to the descending side space (27), and moves the conveyance trays (70) sent in the descending side space (27) downward.

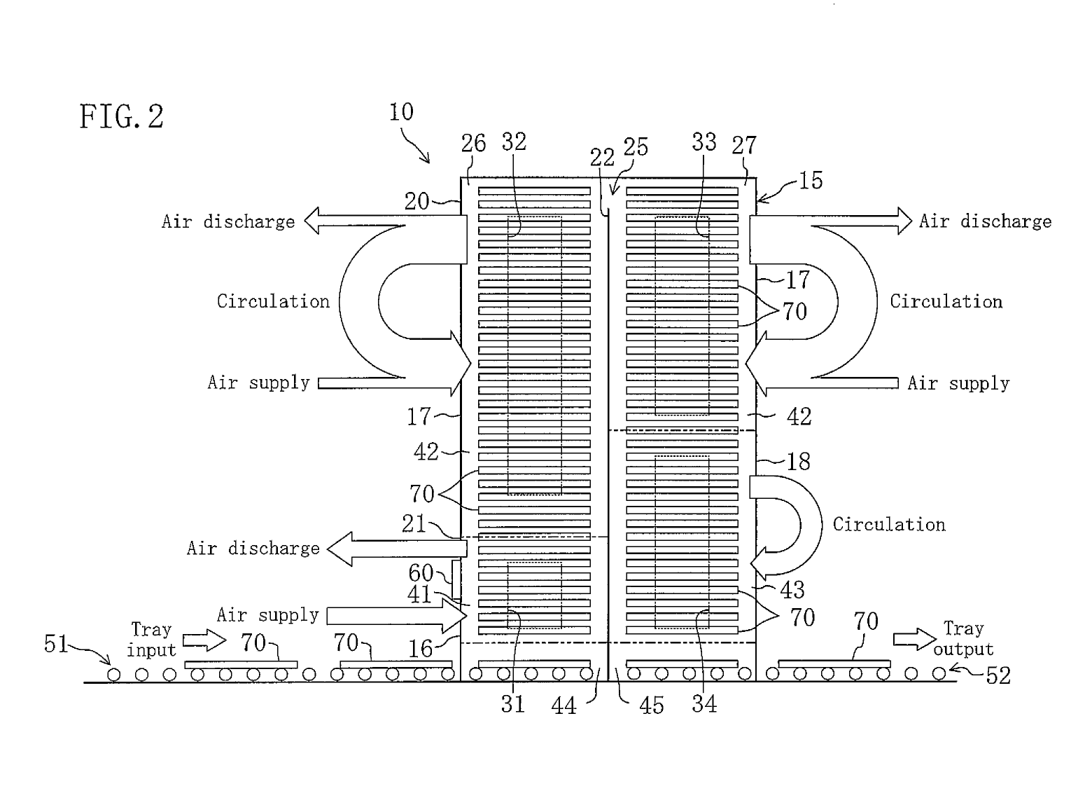

As shown in FIG. 2, the ascending side space (26) forms an input zone (44) at the lower end part thereof, a first dying zone (41) at a part thereof ranging from the upper end of the input zone (44) to a predetermined height, and a second drying zone (42) in the other part thereof located above the first drying zone (41). The descending side space (27) forms an output zone (45) at the lower end part thereof a heat treatment zone (43) at a part thereof ranging from the upper end of the output zone (45) to a predetermined height, and the second drying zone (42) in the other part thereof located above the heat treatment zone (43). In other words, the second drying zone (42) ranges from the ascending side space (26) over to the descending side space (27).

The first drying zone (41) is a space for performing a treatment of irradiating a microwave to the semi-finished product (80) on each conveyance tray (70) for evaporating moisture in the semi-finished product (80), and serves as a first space or an accommodation space. The part of the body casing (20) which forms the first drying zone (41) forms a first zone forming section (21). In the first zone forming section (21), a microwave generator (60) is mounted. The microwave generator (60) generates a microwave, namely, an electromagnetic wave at a frequency in the range between 300 MHz and 30 GHz, both inclusive, and irradiates the generated microwave into the first drying zone (41).

In the body casing (20), a first blowout port (31) is opened in a part of the back surface (i.e., the back side surface) thereof which faces the first drying zone (41), and a first suction port is opened in a part of the front surface (i.e., the front side surface) thereof which faces the first drying zone (41). The body part (15) is configured to perform ventilation of the first drying zone (41). Specifically, the body part (15) heats the outside air taken from the outside up to approximately 80° C., supplies it to the first drying zone (41) through the first blowout port (31), and then exhausts all the taken air outdoors through the first suction port. The part of the body part (15) which forms the first dying zone (41) serves as the first treatment section (16).

The second drying zone (42) is a space for performing a treatment of blowing hot wind to the semi-finished product (80) on each conveyance tray (70) for evaporating the moisture in the semi-finished product (80), and serves as a second space or an accommodation space. A second blowout port (32) is opened in a part of the back surface of the body casing (20) which faces the second drying zone (42) in the ascending side space (26), and a third blowout port (33) is opened in a part of the back surface thereof which faces the second drying zone (42) in the ascending side space (27). In the front surface of the body casing (20), a second suction port is opened in a part thereof which faces the second dying zone (42) in the ascending side space (26), and a third suction port is opened in a part thereof which faces the second drying zone (42) in the descending side space (27).

The body part (15) is so composed to perform ventilation of the second drying zone (42). Specifically, the body part (15) discharges part of the air taken through the second suction port and the third suction port outdoors while mixing the other taken air with the outdoor air to supply the mixed air to the second drying zone (42) through the second blowout port (32) and the third blowout port (33). In doing so, the body part (15) heats the air so that the temperature of the air to be supplied to the second drying zone (42) through the second blowout port (32) and the third blowout port (33) to be approximately 160° C. The part of the body part (15) which forms the second drying zone (42) serves as a second treatment section (17).

The heat treatment zone (43) is a space for performing a treatment of keeping the semi-finished product (90) on each conveyance tray (70) at a predetermined temperature for a predetermined time period, and serves as a third space or an accommodation space. In the body casing (20), a fourth blowout port (34) is opened in a part of its back surface which faces the heat treatment zone (43), and a fourth suction port is opened in a part of its front surface which faces the heat treatment zone (43).

The body part (15) is so composed to allow the air to flow in the heat treatment zone (43) for uniforming the air temperature in the heat treatment zone (43). Specifically, the body part (15) takes the air in the heat treatment zone (43) through the fourth suction port, and returns all the taken air to the heat treatment zone (43) through the fourth blowout port (34). In so doing, the body part (15) appropriately heats the air to be supplied to the heat treatment zone (43) through the fourth blowout port (34) so that the air temperature in the heat treatment zone (43) is kept at approximately 160° C. The part of the body part (15) which forms the heat treatment zone (43) serves as a third treatment section (18).

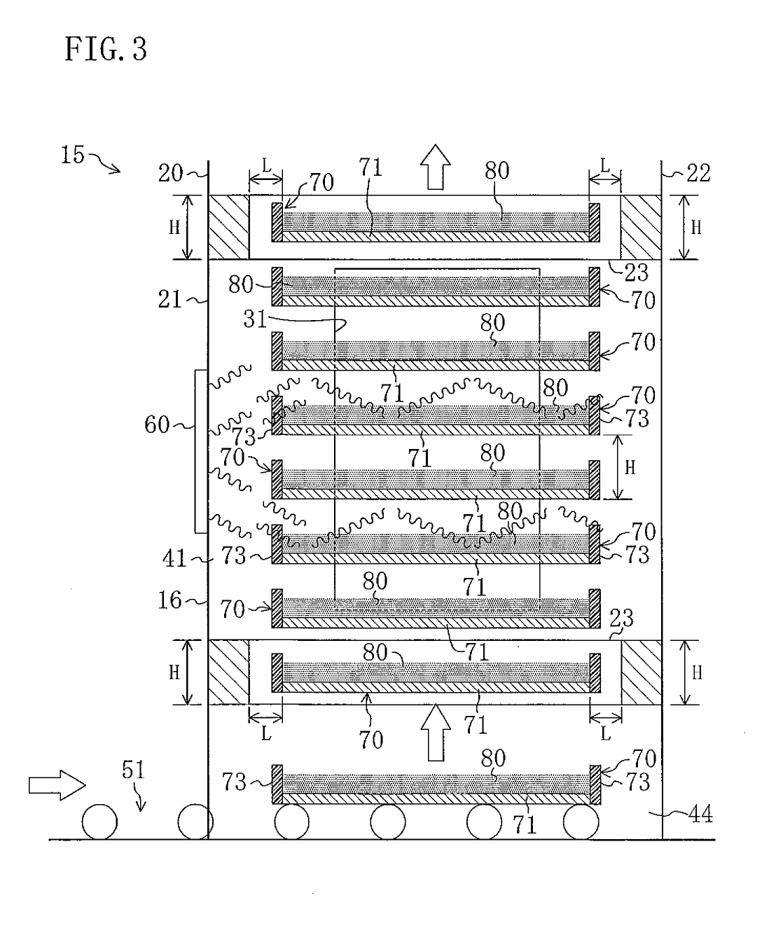

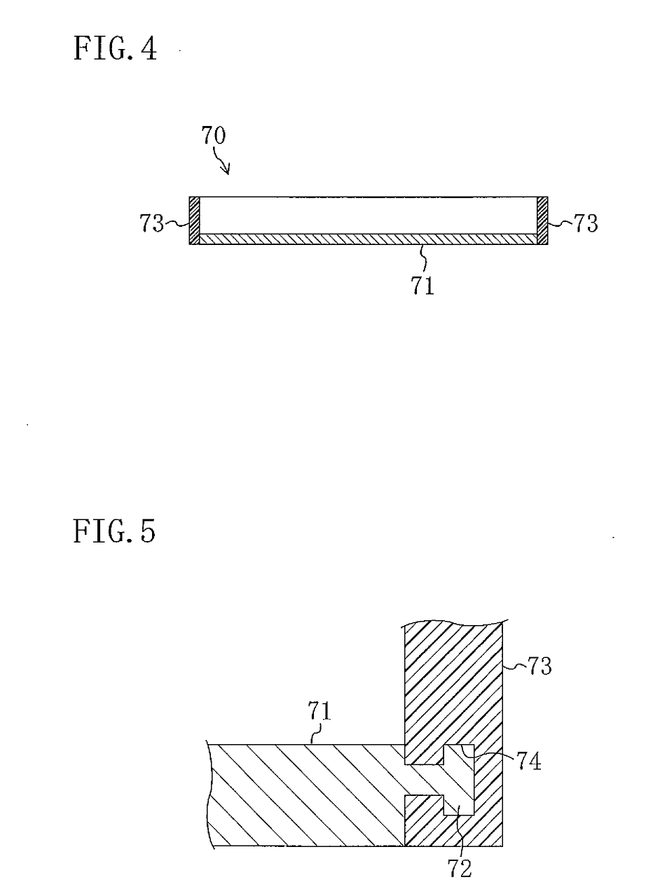

The conveyance trays (70) are substantially in a square form. As shown in FIG. 3 and FIG. 4, each conveyance tray (70) is composed of a metal-made bottom plate member (71) and resin-made side plate members (73). The bottom plate member (71) is substantially in a square plate shape. The side plate members (73) are in a slim oblong rectangular plate shape, and stand along the four sides of the bottom plate member (71). Materials of the bottom plate member (71) include stainless, for example. Materials of the side plate members (73) include polytetrafluoroethylene (PTFE), for example. The side plate members (73) may be made of any material having a small loss factor (namely, material readily transmitting the microwave or hardly absorbing the microwave). As an alternative of the various reins, glass or ceramics may be used, for example.

In each conveyance tray (70), the side plate members (73) are detachable from the bottom plate member (71). As shown in FIG. 5, a protrusion (72) extending along the periphery of the bottom plate member (71) protrudes outward from the periphery. The protrusion (72) has a T-shape in section. The lower part of each side plate member (73) forms a fitting trench (74) extending in the longitudinal direction thereof. The fitting trench (74) is in a T-shape in section so as to correspond to the sectional shape of the protrusion (72). The side plate members (73) are connected to the bottom plate member (73) in such a fashion that the protrusion (72) of the bottom plate member (71) are fitted to the fitting trenches (74) thereof.

As shown in FIG. 3, in the first zone forming section (21) of the body casing (20), metal-made frame members (23) are provided. The frame members (23) are arranged one by one at the inlet and the outlet of the first drying zone in a posture surrounding a conveyance tray (70) moving in the first drying zone.

The inner surfaces of the frame members (23) serves as the inner surfaces of the respective end parts of the inlet and the outlet of the first zone forming section (21), that is, the respective end parts on the lower side and the upper side thereof. Each inner surface of the frame members (23) is a flat surface having a height H. The height H of the inner surface is equal to an interval H between two bottom plate members (71) of adjacent conveyance trays (70) vertically moving in a line in the first drying zone. The interval H is set greater than ¼ of the wavelength λ of the microwave irradiated from the microwave generator (60), that is, λ/4. For example, where the frequency of the microwave generated in the microwave generator (60) is 2.5 GHz, which means that the wavelength λ of the microwave is 120 mm, the interval H is set greater than 30 mm.

In the state that a conveyance tray (70) is located by the side of a frame member (23), the distance L between the bottom plate member (71) of the conveyance tray (70) and the inner surface of the frame member (23) is set below ¼ of the wavelength λ of the microwave irradiated from the microwave generator (60), that is, λ/4. In other words, in the above example (where λ=120 mm), the distance L is set below 30 mm. As described above, the height of each inner surface of the frame members (23) is equal to each interval between the bottom plate members (71) of adjacent conveyance trays (70). Accordingly, the interval between the inner surface of each frame member (23) and the bottom plate member (71) of a conveyance tray (70) which approaches the most to the frame member (23) is always the distance L regardless of the position of the conveyance tray (70).

—Producing Method—

A producing method in the present embodiment is provided for producing dried PTFE powder as a finished product by performing treatment on a semi-finished product (80) obtained as a mixture of PTFE powder and water in a process of producing PTFE powder. This producing method is used for performing a drying method according to the present invention on the above semi-finished product (80) as wet powder.

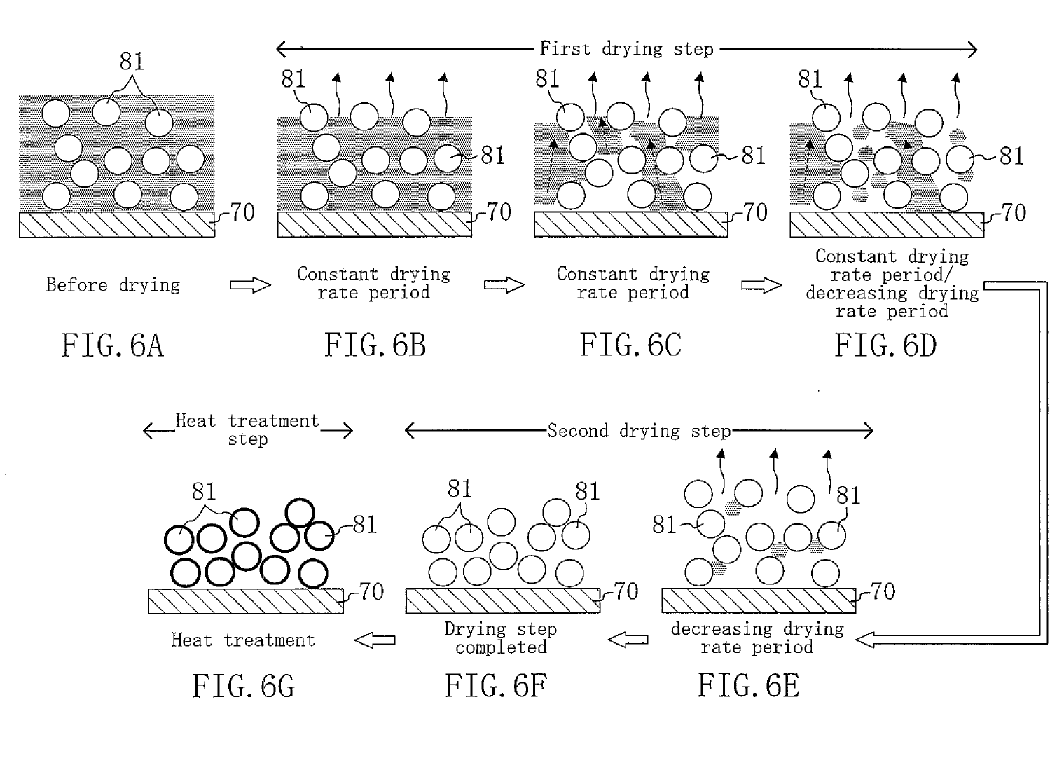

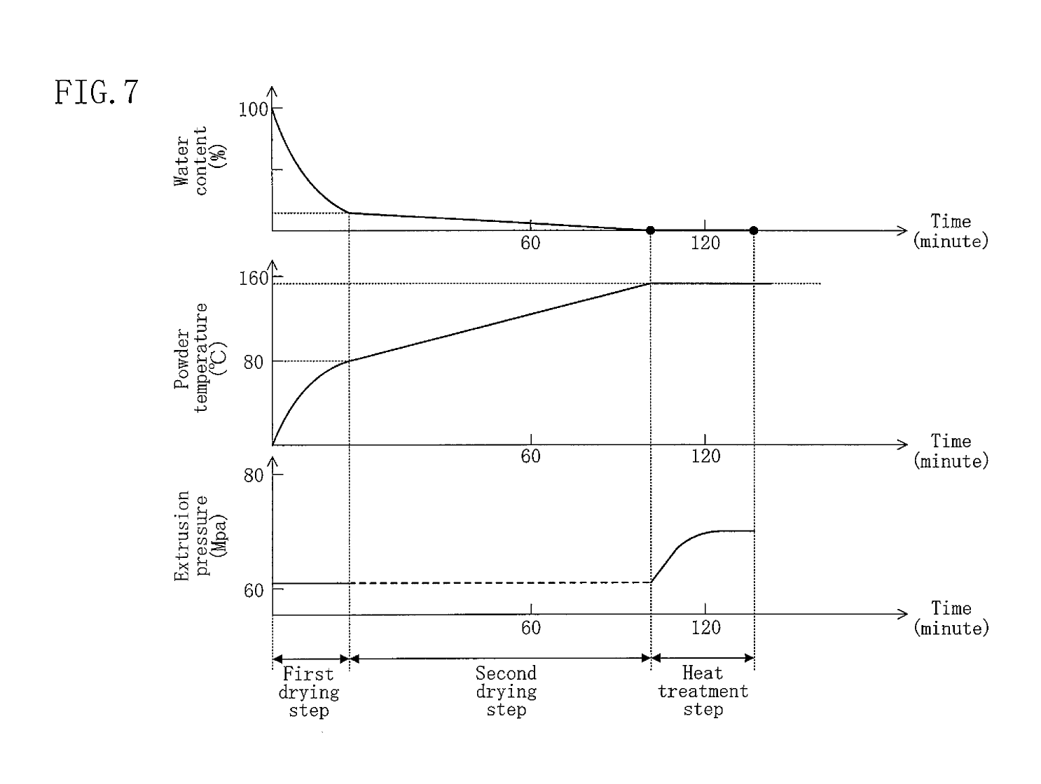

The producing method in the present embodiment is performed by the producing apparatus (10). Accordingly, the producing method will be described as an operation of the producing apparatus (10) herein with reference to FIG. 2, FIG. 6, and FIG. 7.

The semi-finished product (80), which is obtained as a mixture of PTFE powder and water in a step prior to the steps performed in the present producing method, is put on each conveyance tray (70). The semi-finished product (80) put on each conveyance tray (70) is in a layer form of which thickness is almost uniform. The semi-finished product (80) in this state has a water content of almost 100%. Namely, in the semi-finished product (80), water of 100 weight parts is mixed with the PTFE powder of 100 weight parts.

The conveyance trays (70) each carrying the semi-finished product (80) of which the water content is 100% are conveyed by the input side roller conveyer (51) into the input zone (44) of the body part (15). In the semi-finished product (80) on each conveyance tray (70) in the input zone (44), the interstices among PTFE particles (81) are filled with the water thoroughly, as shown in FIG. 6(a). The conveyance trays (70) conveyed to the input zone (44) are moved by the tray driving section (50) upward in the ascending side space (26) of the passage space (25) to be conveyed to the first drying zone (41). The tray driving section (50) moves the conveyance trays (70) at a slow speed of 2 cm per minute, for example.

In the first drying zone (41), a first drying step as a first step is performed on the semi-finished product (80), that is, wet powder on each conveyance tray (70). Specifically, in the first drying zone (41), the conveyed conveyance trays (70) are moved upward slowly, and the semi-finished product (80) on each moving conveyance tray (70) is irradiated with the microwave. The water contained in the semi-finished product (80) increases in its temperature by absorbing the microwave to be evaporated. The water evaporated from the semi-finished product (80), that is, vapor is discharged outdoors together with the air in the first drying zone (41).

As a result, the amount of the water contained in the semi-finished product (80) on each conveyance tray (70) moving in the first drying zone (41) decreases gradually, as shown in FIG. 6 and FIG. 7.

Specifically, in the initial stage of the first drying step, the interstices among the PTFE particles (81) are filled with the water almost completely (see FIG. 6(b)), or the water is present in forms of large blocks in the interstices among the PTFE particles (81) (see FIG. 6(c)). In this state, almost all part of the energy of the microwave which is absorbed in the semi-finished product (80) on each conveyance tray (70) contributes to water evaporation. In other words, the initial stage of the first drying step is a constant drying rate period or a rate drying period.

Referring to the middle to final stages of the first drying step, the semi-finished product (80) is in a state in which the water in forms of comparatively large blocks and the water in forms of comparatively small droplets are present (see FIG. 6(d)). In this state, part of the energy of the microwave which is absorbed in the semi-finished product (80) on each conveyance tray (70) contributes to raising of the temperature of the PTFE particles (81), while the other part thereof contributes to water evaporation. In other words, each of the middle and final stages of the first drying step is a period in which both the constant rate drying and the decreasing rate drying are performed.

In the first drying zone (41), hot wind at a temperature of approximately 80° C. flows, while the microwave is irradiated to the semi-finished product (80) on each conveyance tray (70). In the semi-finished product (80) on each conveyance tray (70), PTFE particles (81) located around the surface thereof is heated by the hot wind, so that the temperature of the PTFE particles (81) increases comparatively quickly. Accordingly, the water evaporated from the semi-finished product (80) is released in the air without being condensed even upon coming into contact with the PTFE particles (81), and is then discharged from the first drying zone (41) together with the air.

In the semi-finished product (80) on a conveyance tray (70) reaching the outlet of the first drying zone (41), the water content thereof is reduced to approximately 20%. The temperature of this semi-finished product (80) (particle temperature) is increased up to approximately 80° C. The conveyance trays (70) each carrying the semi-finished product (70) of which the water content is approximately 20% is conveyed from the first drying zone (41) to the second drying zone (42).

In the second drying zone (42), a second drying step as a second step is performed on the semi-finished product (80), that is, the wet powder on each conveyance tray (70). Specifically, in the second drying zone (42) in the ascending side space (26), the conveyed conveyance trays (70) are moved upward slowly. On the other hand, the second drying zone (42) in the descending side space (27), the conveyed conveyance trays (70) are moved downward slowly. In the second drying zone (42), hot wind at a temperature of approximately 160° C. is blown to the semi-finished product (80) on each moving conveyance tray (70). The water contained in the semi-finished product (80) is heated by the hot wind to be evaporated. The water evaporated from the semi-finished product (80), that is, vapor is discharged outdoors together with the air in the second drying zone (42). The temperature of the hot wind flowing in the second drying zone (42) is set at approximately 160° C. herein, but the temperature of the hot wind may be any arbitrary value higher than the evaporation temperature of water under the atmospheric pressure, that is, 100° C.

As a result, the amount of the water contained in the semi-finished product (80) on each conveyance tray (70) moving in the second drying zone (42) decreases gradually, as shown in FIG. 6 and FIG. 7.

Specifically, at the beginning of the second drying step, the residual water in the semi-finished product (80) is dispersed in the PTFE powder in forms of minute droplets (see FIG. 6(e)). The PTFE has water repellency, and therefore, the residual water in the semi-finished product (80) is dispersed in forms of droplets even in the state where the water content of the semi-finished product (80) is not so low (for example, in the state where the water content is approximately 20%). In this state, part of the heat provided from the hot wind to the semi-finished product (80) contributes to water evaporation, while the other part thereof contributes to raising of the temperature of the PTFE particles (81). In other words, the period when the second drying step is performed is a generally-called decreasing drying rate period.

The water content of the semi-finished product (80) on a conveyance tray (70) reaching the outlet of the second drying zone (42) is reduced to 0.01% or lower. The temperature of the PTFE powder of this semi-finished product (80) is raised to approximately 155° C. The conveyance trays (70) each carrying the semi-finished product (80) of which the water content is nearly 0% are conveyed from the second drying zone (42) to the heat treatment zone (43)

In the heat treatment zone (43), a heat treatment step as a third step is performed on the semi-finished product (80) on each conveyance tray (70), that is, the PTFE for which drying is completed. Specifically, the air temperature in the heat treatment zone (43) is kept at approximately 160° C. In the heat treatment zone (43), the conveyed conveyance trays (70) are moved downward slowly so that the semi-finished product (80) on each conveyance tray (70), that is, the PTFE powder of which the water content is nearly 0% is exposed to the atmosphere at a temperature of 160° C. It takes about 30 minutes to allow the conveyance trays (70) moved into the heat treatment zone (43) to reach the outlet of the heat treatment zone (43). In other words, in the heat treatment zone (43), the temperature of the PTFE powder on each conveyance tray (70) is kept at approximately 155° C. for about 30 minutes, as shown in FIG. 7.

Where the temperature of PTFE powder of which the content water is nearly 0% is kept at certain high temperature, the extrusion pressure (pressure necessary for extrusion molding the PTFE powder) increases gradually in the beginning. When a given time period elapses then, the extrusion pressure becomes almost constant rather than further increases. In view of this, in the heat treatment step performed in the heat treatment zone (43), the temperature of the PTFE powder is kept at approximately 155° C. for over a time period required until the extrusion pressure of the PTFE powder becomes constant. This heat treatment step results in that the extrusion pressure of the PTFE powder as a finished product is in the range between approximately ±7% from a reference value.

On a conveyance tray (70) reaching the lower end part of the heat treatment zone (43), the PTFE powder is put as a finished product. The conveyance trays (70) each carrying the PTFE powder as the finished product are put on the start end part of the output side roller conveyer (52) to be discharged outside the body part (15).

### Advantages of Embodiment 1

In the producing device (10) and the producing method according to the present embodiment, in order to dry the semi-finished product (80) obtained as a mixture of PTFE powder and water, the first drying step using the microwave and the second drying step using the hot wind are performed in this order.

When the water content of a mixture of powder and water becomes lower than a given value, the water is dispersed widely in the powder, rather than gathers at one point. Particularly, since PTFE has high water repellency, almost all part of the water is dispersed in the PTFE powder in forms minute droplets when the PTFE powder contains comparatively less water. For this reason, the semi-finished product (80) of which the water content is reduced to approximately 20% might be in the state that the water is dispersed in the PTFE powder in forms of minute droplets, as shown in FIG. 6(e).

It is known that where a target substance is dried by utilizing a microwave, the ratio of part of the irradiated microwave which is absorbed to the water lowers as the water content of the target substance is lowered. Particularly, the water in the mixture of the PTFE powder having high water repellency and water is liable to come into contact with the PTFE particles (81) to form droplets. For this reason, even if the water content is not so low, the water contained in the semi-finished product (80) is dispersed in forms of minute droplets. Dispersion of water droplets fairly smaller in size than the wavelength of the microwave lowers the absorption rate of the microwave to the water. This results in the state that the temperature of the water droplets is hardly increased even by further microwave irradiation.

To tackle this problem, in the producing device (10) and the producing method according to the present embodiment, water evaporation is promoted by heating by the microwave when the water content of the semi-finished product (80) is comparatively high (namely, when the water is present in the state gathering to some extent in the PTFE powder), while the water evaporation is secured by heating by the hot wind when efficient water absorption by the microwave cannot be achieved due to low water content of the semi-finished product (80) (namely, when the water in the PTFE powder is dispersed in forms of droplets). Hence, according to the present embodiment, the water content of the PTFE powder as the finished product can be reduced to nearly 0%, and selection of the optimum heating method according to the water content of the semi-finished product (80) can lead to thorough drying the semi-finished product (80) within about two to three hours, which has been ten several hours required in the conventional case.

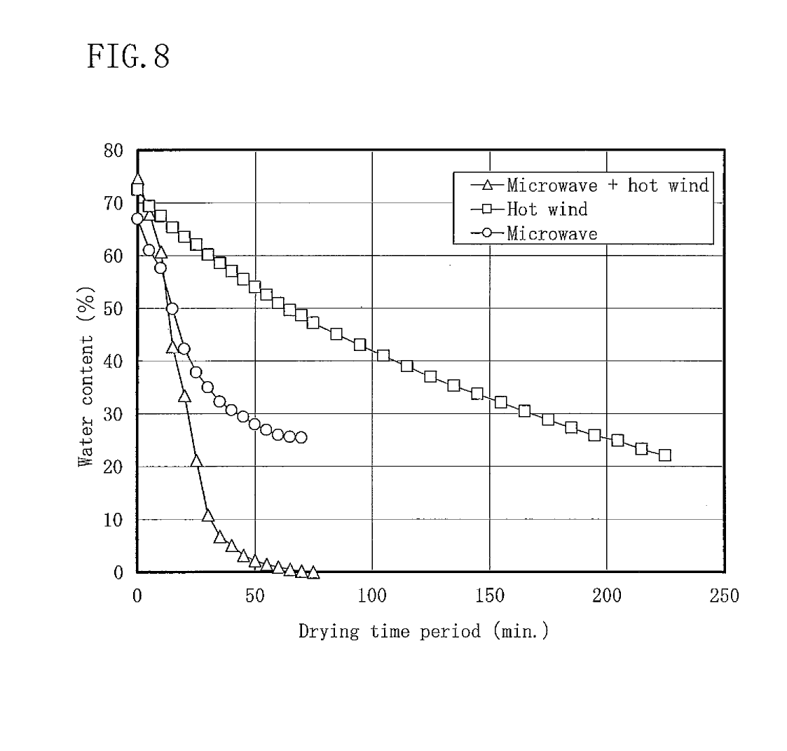

For reference, FIG. 8 shows each relationship between the duration of the drying step (drying period) and the water content of the semi-finished product (80) in the case where the microwave and the hot water are used in combination for drying the semi-finished product (80), in the case where only the hot wind is used therefor, and in the case where only the microwave is used therefor. In the case where only the hot wind is use for heating the semifinished product (80), the water content of the semi-finished product (80) lowers gently, as indicated by square marks plotted in the graph. This means that an extremely long drying time period is required for lowering the water content of the semi-finished product (80) to nearly 0%. In the case where only the microwave is used for heating the semi-finished product (80), while the water content of the semi-finished product (80) lowers sharply immediately after start of microwave irradiation, as indicated by circles plotted in the graph, the rate of lowering the water content slowed after a given time period elapses, and the water content will not be lower than twenty several percentages. In contrast, in the case where the microwave and the hot wind are used in combination for heating the semi-finished product (80), as in the present embodiment, the water content of the semi-finished product (80) sharply lowers, and reaches almost 0% at the time point when about 70 minutes elapses from start of drying.

Since the PTFE powder hardly absorbs the microwave, an increase in temperature of the PTFE powder by microwave irradiation cannot be expected. This has already been mentioned above. For this reason, when the microwave is irradiated to the semi-finished product (80) of which the temperature is around the ambient temperature of the producing apparatus (10) (for example, 20° C.), the temperature of the water in the semi-finished product (80) quickly increases, while the temperature of the PTFE powder in the semi-finished product (80) increases gradually and slowly. In this state, the amount of the residual water of the mixture lowers little by little in may cases. The reason thereof might be that much amount of the water evaporated by heating comes into contact with the low-temperature water repellent powder to be condensed.

To tackle this problem, the producing apparatus (10) of the present embodiment irradiates the microwave to the semi-finished product (80) on each conveyance tray (70), and allows the hot wind at a temperature near the boiling point of water, for example, about 80° C. to 100° C. to flow in the first drying zone (41). As a result, in the semi-finished product (80) on each conveyance tray (70), PTFE particles around the surface thereof is heated by the hot wind to increase in temperature comparatively quickly. Accordingly, the water evaporated from the semi-finished product (80) is released in the air without being condensed even if it comes into contact with the PTFE particles (81), and is then discharged from the first drying zone (41) together with the air. Hence, according to the present embodiment, the amount of part of the evaporated water which comes into contact with the PTFE particles (81) to be condensed can be reduced remarkably, with a result that the amount of the residual water in the mixture can be reduced quickly.

In the present embodiment, while the heat treatment step is performed for making the extrusion pressure of the PTFE powder as the finished product to be within a predetermined target range, the semi-finished product (80) is heated by the hot wind in the second drying step performed immediately before the heat treatment step. When the semi-finished product (80) is heated by the hot wind, not only the temperature of the residual water in the semi-finished product (80) but also that of the PTFE powder increases. In the present embodiment, the temperature of the hot wind supplied to the second drying zone (42) is equal to that of the hot wind supplied to the heat treatment zone (43), and therefore, the temperature of the PTFE powder has already reached a target temperature for heat treatment at the time point when the heat treatment starts. Hence, according to the present embodiment, the time period required for the heat treatment can be reduced to reduce the total time period required for obtaining the PTFE powder as the finished product from the semi-finished product (80).

In the producing apparatus (10) of the present embodiment, the conveyance trays (70) each carrying the semi-finished product (80) are arranged vertically in the body part (15), and a plurality of vertically arranged conveyance trays (70) are moved vertically for drying the semi-finished product (80) on each conveyance tray (70). In the case where the conveyance trays (70) are arranged horizontally, the floor space that the arranged conveyance trays (70) occupy is a value calculated by multiplying the area of the base of a conveyance tray (70) by the number of the conveyance trays (70). In contrast, where a plurality of conveyance trays (70) are arranged vertically in two lines as in the present embodiment, the floor space that the arranged conveyance trays (70) occupy is only twice as much as the area of the base of a conveyance tray (70). Accordingly, when a plurality of conveyance trays (70) are arranged vertically as in the present embodiment, the floor space that the body part (15) of the producing apparatus (10) occupies can be reduced remarkably to lead to size reduction of the producing apparatus (10).

In the producing apparatus (10) of the present embodiment the passage space (25) in the body part (15) is divided into the ascending side space (26) and the descending side space (27) so that the conveyance trays (70) are moved upward in the ascending side space (26) while being moved downward in the descending side space (27). In other words, the conveyance trays (70) are moved upward in the ascending side space (26) of the passage space (25), and are then moved in reverse downward in the descending side space (27) thereof. Hence, according to the present embodiment, the height of the body member (15) can be suppressed low when compared with the case where the conveyance trays (70) are arranged only in the upward direction or the downward direction in the body member (15).

In the present embodiment, the first drying zone (41) is kept at a temperature of approximately 80° C., while being ventilated. Hence, according to the present embodiment, water evaporation from the semi-finished product (80) can be promoted by keeping the relative humidity in the first drying zone (41) low, and the water evaporated from the semi-finished product (80) can be discharged from the first drying zone (41) quickly. Thus, the time period required for the first drying step can be reduced.

In the producing apparatus (10) of the present embodiment, the first drying step and the second drying step are performed to lower the water content of the PTFE powder as the semi-finished product (80) to nearly 0%, and therefore, ventilation of the heat treatment zone (43) for performing the heat treatment is unnecessary. Accordingly, the heat required for keeping the air temperature of the heat treatment zone (43) at the predetermined value can be reduced, thereby leading to reduction in energy required for producing the PTFE powder.

In the producing apparatus (10) of the present embodiment, the bottom plate member (71) of each conveyance tray (70) arranged vertically in the passage space (25) of the body part (15) is made of metal, and each conveyance tray (70) is irradiated with the microwave from the microwave generator (60) provided by one side of the vertically arranged conveyance tray (70). In general, metal has a property of reflecting microwaves. Accordingly, the microwave irradiated from one side of the conveyance trays (70) is reflected by the top surfaces of lower bottom plate members (71) and the bottom surfaces of upper bottom plate members (71) to reach all over a part remote from the microwave generator (60). Hence, according to the present embodiment, the entirety of the semi-finished product on each conveyance tray (70) in the first drying zone (41) can be heated uniformly by the microwave.

In the producing apparatus (10) of the present embodiment, the side plate members (73) of the conveyance trays (70) are made of resin having a property of transmitting microwaves. Accordingly, the microwave irradiated from the microwave generator (60) provided by one side of the vertically arranged conveyance trays (70) passes through the side plate members (73) to reach the semi-finished product (80) with less or no loss. Hence, according to the present embodiment, the microwave irradiated from the microwave generator (60) can be utilized for drying the semi-finished product (80) with waste avoided.

In the producing apparatus (10) of the present embodiment, the metal-made frame members (23) are provided at the lower end part and the upper end part of the first drying zone (41) so that the distance L between each inner face of each frame member (23) and the bottom plate member (71) of a conveyance tray (70) is set below ¼ of the wavelength λ of the microwave irradiated from the microwave generator (60), that is, λ/4. Electromagnetic waves including the microwave cannot pass through a space between metal-made members where the space is below ¼ of the wavelength of the electromagnetic wave. Further, the body casing (20) is made of metal in the producing apparatus (10) of the present embodiment. Hence, the microwave is prevented from leaking from the first drying zone (41) to secure the safety of the producing apparatus (10).

In the producing apparatus (10) of the present embodiment, the first drying step, the second drying step, and the heat treatment step are performed in this order on the semi-finished product (80) on each conveyance tray (70) with vertically arranged multiple conveyance trays (70) moved in one direction. Accordingly, even in the case where the semi-finished product (80) obtained through the PTFE powder producing process are treated with it put on a plurality of conveyance trays (70), the respective treatments can be performed on the semi-finished product (80) on each of the conveyance trays (70) under the respective same processing conditions (for example, temperature and flow rate of the hot wind abutting on the semi-finished product (80)). Hence, the characteristics (specifically, the water content and the extrusion pressure) of the PTFE powder on the conveyance trays (70) conveyed out from the body part (15) can be uniformed, thereby obtaining PTFE powder having stable quality.

### Embodiment 2

Embodiment 2 of the present invention will be described. In the present embodiment, a preheating zone (46) is formed in the body part (15) of the producing apparatus (10) in Embodiment 1 so that a preheating step of heating the semi-finished product (80) is performed in the preheating zone (46). Herein, only difference from Embodiment 1 in construction and operation of the producing apparatus (10) in the present embodiment will be described.

—Producing Apparatus—

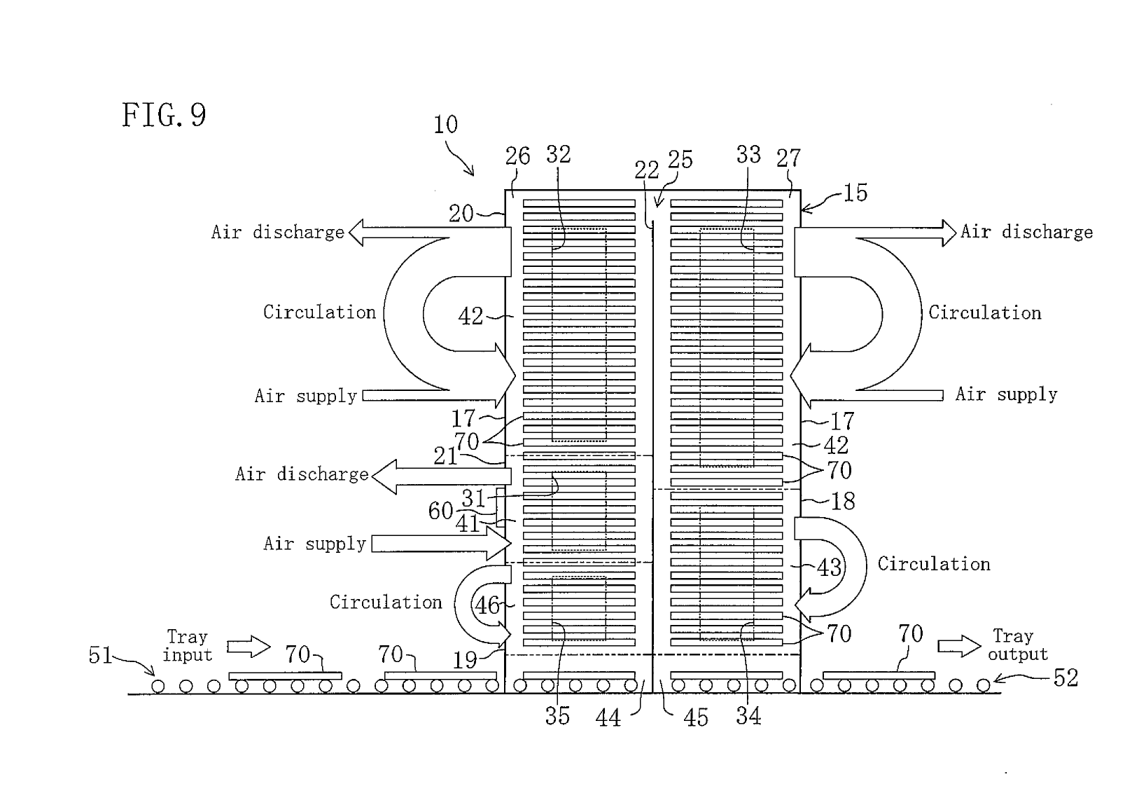

In the producing apparatus (10) of the present embodiment, as shown in FIG. 9, a part of the ascending side space (26) of the body part (15) forms a reheating zone (46). Specifically, the ascending side space (16) includes an input zone (44) at the lower end part thereof, a preheating zone (46) ranging from the upper end of the input zone (44) to a part at a predetermined height, a first drying zone (41) ranging from the upper end of the preheating zone (46) to a part at a predetermined height, and a second drying zone (42) in the remaining part located above the first drying zone (41).

The preheating zone (46) is a space for raising the temperature of the semi-finished product (80) on each conveyance tray (70) by heating, and serves as a preheating space or an accommodation space. In the body casing (20), a preheating blowout port (35) is opened in a part of the back surface, that is, the back side surface thereof which faces the preheating zone (46), while a preheating suction port is opened in a part of the front surface, that is the front side surface thereof which faces the preheating zone (46).

The body part (15) is so composed to allow the air to flow in the preheating zone (46) for heating the semi-finished product (80) input in the preheating zone (46). Specifically, the body part (15) takes the air in the preheating zone (46) through the preheating suction port, and returns all of the taken air to the preheating zone (46) through the preheating blowout port (35). In so doing, the body part (15) heats the air taken through the preheating suction port up to approximately 80° C., for example, and supplies the heated air to the preheating zone (46) through the preheating blowout port (35). A part of the body part (15) which forms the preheating zone (46) serves as a preheating section (19).

—Producing Method—

A producing method performed by the producing apparatus (10) of the present embodiment will be described.

In the producing apparatus (10), the conveyance trays (70) conveyed to the input zone (44) are moved to the preheating zone (46) by the tray driving section (50). At this time point, the temperature of the semi-finished product (80) on each conveyance tray (70) is almost equal to the ambient temperature of the producing apparatus (10), for example, around 20° C.

In the preheating zone (46), a preheating step is performed on the semi-finished product (80), that is, wet powder on each conveyance tray (70). Specifically, in the preheating zone (46), the conveyed conveyance trays (70) are moved upward slowly so that the semi-finished product (80) on each moved conveyance tray (70) is exposed to the hot wind flowing in the preheating zone (46). The semi-finished product (80) is heated by the hot wind to increase in temperatures of the PTFE particles (81) and the water contained therein. At the time point when a conveyance tray (70) reaches the outlet of the preheating zone (46), each temperature of the PTFE particles (81) and the water contained in the semi-finished product (80) is fairly higher than that at the time point when the conveyance tray (70) is conveyed to the preheating zone (46) (for example, approximately 60° C. to 70° C.). The conveyance trays (70) each carrying the semifinished product (80) heated in the preheating zone (46) are conveyed from the preheating zone (46) to the first drying zone (41).

In the first drying zone (41), the semi-finished product (80) on each conveyed conveyance tray (70) is irradiated with the microwave. The first drying step performed in the first drying zone (41) is the same as that performed in the producing apparatus (10) shown in FIG. 2. Namely, the water contained in the semi-finished product (80) absorbs the microwave to increase in temperature, thereby being evaporated and being released in the air.

### Advantages of Embodiment 2

As described above, it is inferred that where the microwave is irradiated to the semi-finished product (80) of which the PTFE particles (81) is not so high in temperature, a phenomenon might be caused in which while the water contained in the semi-finished product (80) absorbs the microwave to be evaporated once, the evaporated water comes into contact with the low-temperature PTFE particles (81) to be condensed, thereby being returned to a liquid state again.

In contrast, in the present embodiment, the semi-finished product (80) on each conveyance try (70) conveyed in the first drying zone (41) has been heated in the preheating zone (46) to be comparatively high in temperature. Accordingly, in the first drying zone (41) in the present embodiment, in which the microwave is irradiated to the semi-finished product (80) of which the temperature has already been high, the water in the semi-finished product (80) absorbs the microwave to be evaporated at a dash, and is released in the air without being condensed even if it comes into contact with the PTFE particles (81). Hence, according to the present embodiment, the amount of part of the evaporated moisture which is condensed by coming into contact with the PTFE particles (81) can be reduced remarkably to lead to reduction in time period required for the first drying step in the first drying zone (41).

### Other Embodiments

Each of the producing apparatuses (10) and the producing methods in the above embodiments may employ any of the following modified examples.

### Modified Example 1

In any of the above producing apparatuses (10), a plurality of microwave generators (60) may be provided at the body part (15).

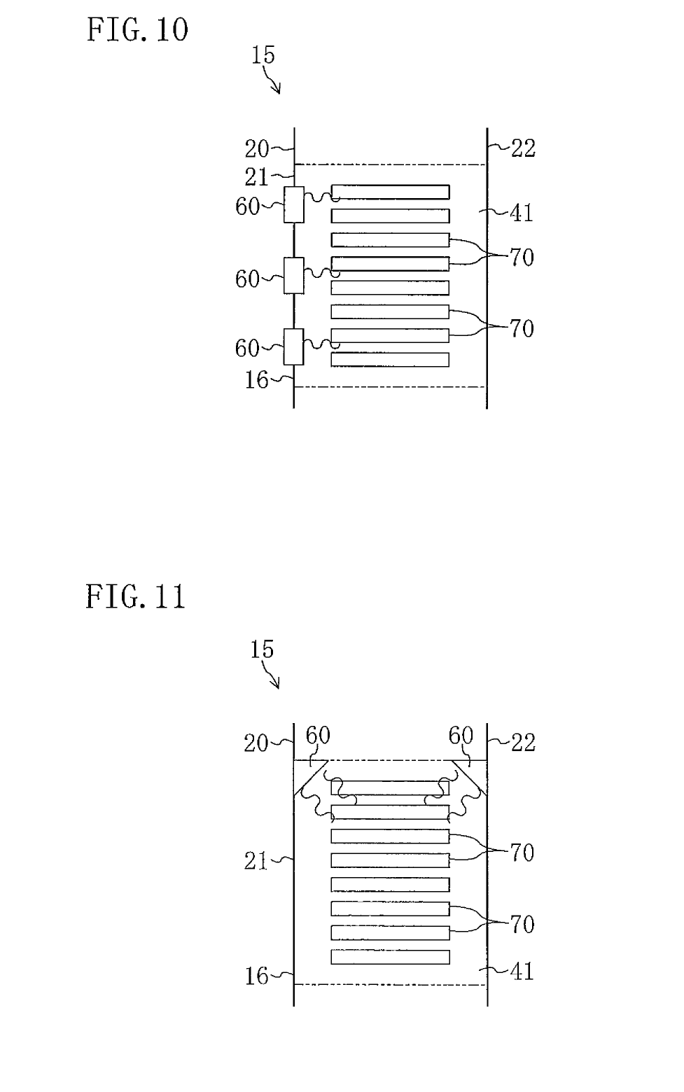

For example, as shown in FIG. 10, the plurality of microwave generators (60) may be arranged vertically in a line along the side wall of the first zone forming section (21). Alternatively, the plurality of microwave generators (60) may be arranged at the upper corners of the first drying zone (41), as shown in FIG. 11.

### Modified Example 2

In any of the above producing apparatuses (10), a member for scattering the generated microwave may be provided in front of the microwave generator (60).

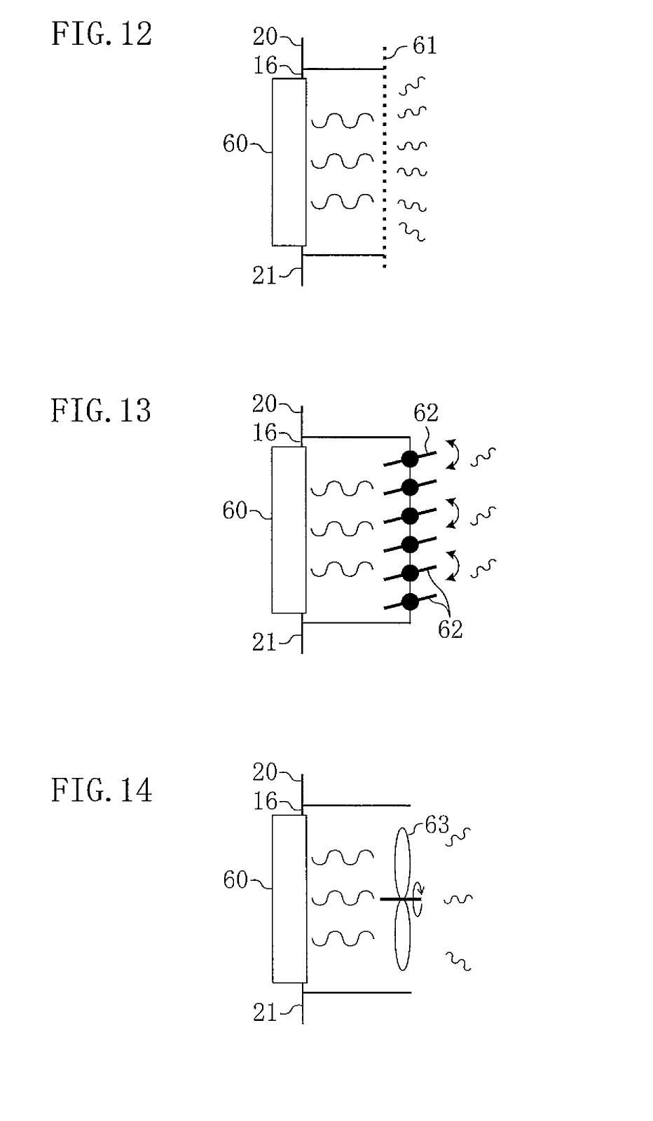

For example, as shown in FIG. 12, a perforated metal sheet (61) is disposed in front of the microwave generator (60) to scatter the microwave irradiated from the microwave generator (60).

Alternatively, as shown in FIG. 13, a plurality of metal-made flaps (62) are arranged in front of the microwave generator (60), and each angle of the flaps (62) is adjusted so that the microwave irradiated from the microwave generator (60) is scattered.

Or, as shown in FIG. 14, a stirrer (63) formed with a metal-made propeller is disposed in front of the microwave generator (60) so that the microwave irradiated from the microwave generator (60) is scattered by the rotating stirrer (63).

### Modified Example 3

In each of the above producing apparatuses (10), the body casing (20) is made of metal as a whole. Alternatively, only the first zone forming section (21) thereof may be made of metal, while the other part thereof is made of a material other than metal.

### Modified Example 4

In each of the above producing apparatuses (10), the conveyance trays (70) are moved continuously at slow speed (for example, about 2 cm per minute). The conveyance trays (70) may be moved intermittently at predetermined time intervals. In this case, the conveyance trays (70) are moved 10 cm by 10 cm every five minutes, for example. Namely, in this example, each conveyance tray (70) is moved by only 10 cm and is then held at that point. After five minutes elapses from the time point when immediately prior movement of the conveyance trays (70) starts, the conveyance trays (70) are moved ahead further by only 10 cm.

### Modified Example 5

Each of the above producing apparatuses (10) and the producing methods in the above embodiments is directed to PTFE as one kind of fluorine containing resin, but targets thereof are not limited to PTFE. For example, the producing apparatuses (10) and the producing methods of the embodiments may be used for producing powder of, for example, any of a copolymer of tetrafluoroethylene and hexafluoropropylen (FEP), a copolymer of tetrafluoroethylene and perfluoro-alkyl vinyl ether (PEA), polychlorotrifluoroethylene (PCTFE), polyvinylidene fluoride (PVDF), a copolymer of ethylene and tetrafluoroethylene (ETFE), a copolymer of ethylene and chlorotrifluoroethylene (ETFE), and the like.

The powder produced by any of the producing devices (10) and any of the producing methods of the above embodiments is powder made of a material having water repellency, that is, water repellent powder, and is not limited to powder made of fluorine containing resin. It is generally known that a contact angle of a water droplet on the surface of a solid serves as an index of the water repellency, and it is generally said that if the contact angle of a droplet on the surface of a solid made of a given material is 90 degrees or larger, the material has water repellency.

Such water repellent powders include powder of generalized resin, generally-called engineering plastic powder, and the like. Specifically, water repellent powders include, for example, powder of any of polyethylene, polyvinyl chloride, polypropylene, polystyrene, polyvinyl acetate, ABS resin (acrylonitrile butadiene styrene resin), AS resin (acrylonitrile-styrene resin), methacrylate resin, polyacetal, polyamide, polyimide, polyamide-imide, polycarbonate, polyphenylene ether, polybutylene terephthalate, polyarylate, polysulfone, polyether sulfone, polyether-imide, polyphenylene sulfide, polyether ether ketone, fluorine containing resin, and the like.

The preheating step may be unnecessary according to the kind or use of target water repellent powder. In such a case, the third treatment section (18) is omitted from the body part (15) of the producing apparatus (10) so as to perform only the first drying step and the second drying step.

### Modified Example 6

In the third treatment section (18) of each producing apparatus (10) of the above embodiments, a step (impurity removing step) of removing residual impurities in the semi-finished product (80) by making it to evaporate may be performed. In other words, this impurity removing step may be performed as a third step in each producing method of the above embodiments.

In a PTFE powder producing process, a fluorine containing emulsifier, such as ammonium perfluorooctanoate or the like may be added for the purpose of promoting a reaction for generating PTFE particles (81), for example. Addition of such an additive may cause the additive to remain in the semi-finished product (80) as an impurity. To tackle this problem, in the impurity removing step in the present modified example keeps the temperature of the semi-finished product (80) higher than the boiling point and the sublimation point of the impurity contained therein. For example, in the case using ammonium perfluorooctanoate as an additive, of which the sublimation point is approximately 120° C., the temperature of the semi-finished product (80) is kept higher than 120° C. When the temperature of the semi-finished product (80) is kept higher than the boiling point of an impurity, the impurity in the semi-finished product (80) is evaporated to be removed from the PTFE powder.

In the impurity removing step in the present modified example, it is preferable to discharge the evaporated impurity from the third treatment section (18). Accordingly, it is preferable in the third treatment section (18) in the present modified example to allow hot wind of which the temperature is higher than the boiling point of the impurity to flow in a space accommodating the semi-finished product (80) while ventilating the space.

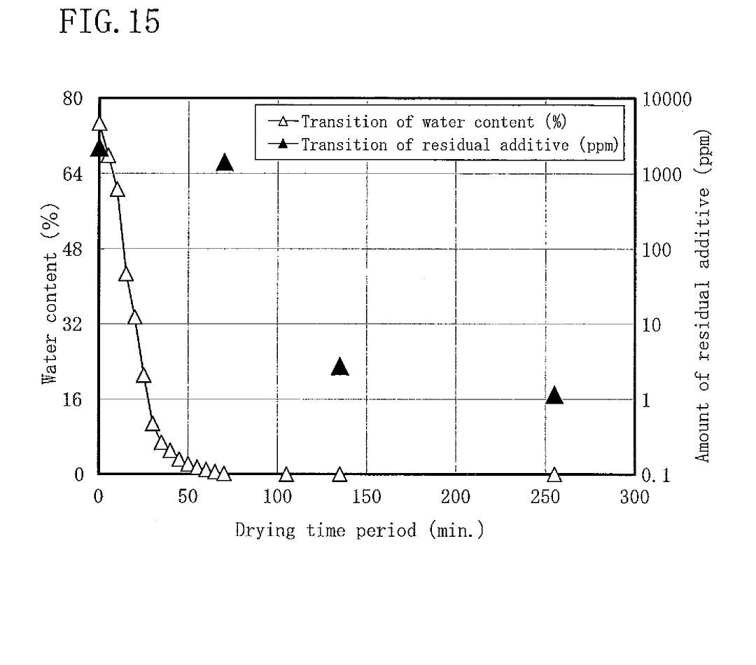

As indicated by open triangular marks plotted in FIG. 15, the water content of the semi-finished product (80) sharply decreases during the time until a conveyance tray (70) reaches the third treatment section (18), and becomes nearly 0% at the time when the conveyance tray (70) is conveyed into the third treatment section (18). In contrast, the residual amount of the additive in the semi-finished product (80) starts decreasing at a point where the conveyance tray (70) passes the middle point of the second treatment section (17), and finally lowers to several ppm at the time point when the conveyance tray (70) reaches the outlet of the third treatment section (18). In other words, since the temperature of the PTFE particles (81) is much lower than the boiling point of the additive until the conveyance tray (70) reaches the middle point of the second treatment section (17), the additive is hardly evaporated from the PTFE particles (81). Then, the temperature of the PTFE particles (81) becomes higher than the boiling point of the additive when the conveyance tray (70) reaches the third treatment section (18), with a result that the additive is evaporated actively.

Where the semifinished product (80) is kept at approximately 160° C. for a certain period of time in the third treatment section (18) in the present modified example, the impurity is evaporated from the PTFE powder, while the extrusion pressure of the PTFE powder is stabilized. In other words, in is case, the third treatment section (18) performs the impurity removing step of evaporating the impurity from the PTFE power and the heat treatment step for stabilizing the extrusion pressure of the PTFE powder simultaneously in parallel.

The above embodiments are mere essentially preferred examples, and are not intended to limit the scopes of the present invention, applicable subjects, and use.

### INDUSTRIAL APPLICABILITY

As described above, the present invention is useful in a process of obtaining water repellent powder as a finished product by drying a mixture of water repellent powder, such as PTFE powder or the like and water.

1. A water repellent powder drying method comprising:
a first step of evaporating, by irradiating a microwave to wet powder (80) which is a mixture of water repellent powder and water, the water contained in the wet powder (80); and
a second step of obtaining dried water repellent powder by heating the wet powder (80) obtained in the first step by hot wind to evaporate residual water in the wet powder (80).

2. The method of claim 1, further comprising:
a third step of keeping the water repellent powder obtained in the second step at a predetermined temperature for a predetermined time period.

3. The method of clam 2, wherein
the wet powder (80) is put on a conveyance tray (70), and the conveyance tray (70) carrying the wet powder (80) is moved along a single path to pass through a space (41) for performing the first step, a space (42) for performing the second step, and a space (43) for performing the third step in this order.

4. The method of claims 2 or 3, wherein
in the second step, the wet powder (80) is accommodated in an accommodation space (42) in which ventilation is performed, and the hot wind is allowed to flow in the accommodation space (42), and
in the third step, the water repellent powder is accommodated in another accommodation space (43) in which no ventilation is performed, and the air temperature of the other accommodation space (43) is kept at a predetermine value.

5. The method of claim 1 or 2, wherein
in the first step, the wet powder (80) accommodated in an accommodation space (41) is irradiated with the microwave, while the accommodation space (41) is ventilated.

6. The method of claim 1 or 2, further comprising,
a preheating step of preheating the wet powder (80) immediately before the first step.

7. The method of claim 1 or 2, wherein
the water repellent powder is powder of polytetrafluoroethylene.

8. The method of claim 2, wherein
in the third step, in order to evaporate an impurity contained in the water repellent powder, the temperature of the water repellent powder is kept higher than the boiling point of the impurity.

9. A method for producing water repellent powder as a finished product by performing treatment on a semi-finished product (80) obtained as a mixture of water repellent powder and water in a process of producing the water repellent powder, comprising:
a first step of evaporating the water contained in the semi-finished product (80) by irradiating a microwave to the semi-finished product (80); and
a second step of evaporating residual water in the semi-finished product (80) obtained in the first step by heating the semi-finished product (80) by hot wind.

10. The method of claim 9, further comprising;
a third step of obtaining the water repellent powder as the finished product by keeping the semi-finished product (80) obtained in the second step at a predetermined temperature for a predetermined time period.

11. The method of claim 10, wherein
the semi-finished product (80) is put on a conveyance tray (70), and the conveyance tray (70) carrying the semi-finished product (80) is moved along a single path to pass through a space (41) for performing the first step, a space (42) for performing the second step, and a space (43) for performing the third step in this order.

12. The method of claim 10 or 11, wherein
in the second step, the semi-finished product (80) is accommodated in an accommodation space (42) in which ventilation is performed, and the hot wind is allowed to flow in the accommodation space (42), and
in the third step, the semi-finished product (80) is accommodated in another accommodation space (43) in which no ventilation is performed, and the air temperature of the other accommodation space (43) is kept at a predetermine value.

13. The method of claim 9 or 10, wherein
in the first step, the semifinished product (80) accommodated in an accommodation space (41) is irradiated with the microwave, while the accommodation space (41) is ventilated.

14. The method of claim 9 or 10, further comprising:
a preheating step of preheating the semi-finished product (80) immediately before the first step.

15. The method of claim 9 or 10, wherein
the water repellent powder is powder of polytetrafluoroethylene.

16. The method of claim 10, wherein
in the third step, in order to evaporate an impurity contained in the semi-finished product (80), the temperature of the semi-finished product (80) is kept higher than the boiling point of the impurity.

17. An apparatus for producing water repellent powder as a finished product by performing treatment on a semi-finished product (80) obtained as a mixture of water repellent powder and water in a process of producing the water repellent powder, comprising:
a first treatment section (16) forming a first space (41) for accommodating the semi-finished product (80), and evaporating the water contained in the semi-finished product (80) by irradiating a microwave to the semi-finished product (80) in the first space (41); and
a second treatment section (17) forming a second space (42) for accommodating the semi-finished product (80) having passed through the first treatment section (16), and evaporating residual water in the semi-finished product (80) by heating the semi-finished product (80) in the second space (42) by hot wind.

18. The apparatus of claim 17, further comprising:
a third treatment section (18) forming a third space (43) for accommodating the semi-finished product (80) having passed through the second space (17), and obtaining the water repellent powder as the finished product by keeping the semi-finished product (80) in the third space (43) at a predetermined temperature for a predetermined time period.

19. The apparatus of claim 18, further comprising:
a conveyance tray (70) for carrying the semi-finished product (80); and
a conveyance mechanism (50) conveying the conveyance tray (70) carrying the semi-finished product (80) along a single path so that the conveyance tray (70) passes through the first treatment section (16), the second treatment section (17), and the third treatment section (18) in this order.

20. The apparatus of claim 18 or 19, wherein
the second treatment section (17) allows the hot wind to flow in the second space (42) while performing ventilation of the second space (42), and
the third treatment section (18) keeps the air temperature in the third space (43) at a predetermined value while performing no ventilation of the third space (43).

21. The apparatus of claim 17 or 18, wherein
the first treatment section (16) ventilates the first space (41).

22. The apparatus of claim 17 or 18, further comprising:
a reheating section (19) forming a preheating space (46) for accommodating the semi-finished product (80) immediately before being sent to the first treatment section (16), and heating the semi-finished product (80) in the preheating space (46).

23. The apparatus of claim 17 or 18, wherein
the water repellent powder is powder of polytetrafluoroethylene.

24. The apparatus of claim 18, wherein
the third treatment section (18) keeps, for evaporating an impurity contained in the semi-finished product (80), the temperature of the semi-finished product (80) higher than the boiling point of the impurity.
